(19) United States
(12) Patent Application Publication
(10) Pub. No.: US 2026/0196924 A1
(43) Pub. Date: Jul. 9, 2026

(54) TRANSFORMER MODULE AND SOLID STATE TRANSFORMER

(71) Applicant: DELTA ELECTRONICS, INC., Taoyuan City (TW)

(72) Inventors: Yi-Li SU, Taoyuan City (TW); Wen-Lung HUANG, Taoyuan City (TW); Chang-Hung LIAO, Taoyuan City (TW); Po-Yi YEH, Taoyuan City (TW)

(21) Appl. No.: 19/096,757

(22) Filed: Apr. 1, 2025

(30) Foreign Application Priority Data
Jan. 9, 2025 (CN) 202510035055.4

(51) Int. Cl. H02M 1/32; H02M 1/00; H02M 3/335; H02M 7/219

(52) U.S. Cl. CPC H02M 1/32; H02M 1/007; H02M 3/33561; H02M 3/33573; H02M 3/33592; H02M 7/219

(57) ABSTRACT

A transformer module includes an AC-DC converter, a DC-DC converter and a controller. The AC-DC converter receives an AC voltage and includes a first bridge arm, a second arm and a DC link. The first bridge arm has a plurality of first switches. The DC link is configured to generate a DC link voltage. The DC-DC converter is configured to receive the DC link voltage and includes a plurality of second switches. This controller is configured to: detecting a first detection signal of the AC-DC converter and a second detection signal of the DC-DC converter; in response to the first detection signal being in an abnormal state, reducing the DC link voltage through the second switches; and in response to the second detection signal being in the abnormal state, reducing the DC link voltage through the first switches.

### CROSS - REFERENCE TO RELATED APPLICATION

This application claims priority to China Application Serial Number 202510035055.4, filed January 09, 2025, which is herein incorporated by reference in its entirety.

### BACKGROUND

### Field of Invention

This disclosure relates to a transformer module and a solid state transformer, and in particular to the transformer module and the solid state transformer related to DC link voltage level.

### Description of Related Art

When a transformer module in a solid state transformer enters a bypass mode, the ideal circumstance is that DC link voltage of the transformer module decreases over time. However, in the well-known technology, the DC link voltage may actually increase over time since the stray capacitance inside the transformer module may discharge in the bypass mode, causing the DC link voltage to increase, thereby causing damage to other internal components of the transformer module.

How to offset the discharge voltage of the stray capacitance in the transformer module in the bypass mode and reduce the DC link voltage is an important issue for people having ordinary skill in this art.

### SUMMARY

The present disclosure provides a transformer module. The transformer module comprises an AC-DC converter, a DC-DC converter, and controller. The AC-DC converter is configured to receive an AC voltage, comprising: a bypass switch circuit; a first bridge arm, coupled to the bypass switch circuit, having a plurality of first switches; a second bridge arm, coupled to the first bridge arm; and a DC link, coupling the first bridge arm and the second bridge arm, configured to generate a DC link voltage. The DC-DC converter is coupled to the DC link, configured to receive the DC link voltage, and comprising: a plurality of second switches, coupled to the DC link. The controller is coupled to the AC-DC converter and the DC-DC converter and configured to: detect a first detection signal of the AC-DC converter and a second detection signal of the DC-DC converter; in response to the first detection signal being in an abnormal state, reduce the DC link voltage through the second switches; and in response to the second detection signal being in the abnormal state, reduce the DC link voltage through the first switches.

The present disclosure provides a solid state transformer. The solid state transformer receives an AC voltage, and comprises a plurality of transformer modules. Each of the transformer modules comprises an AC-DC converter, a DC-DC converter, and controller. The AC-DC converter is configured to receive an AC voltage, comprising: a bypass switch circuit; a first bridge arm, coupled to the bypass switch circuit, having a plurality of first switches; a second bridge arm, coupled to the first bridge arm; and a DC link, coupling the first bridge arm and the second bridge arm, configured to generate a DC link voltage. The DC-DC converter is coupled to the DC link, configured to receive the DC link voltage, and comprising: a plurality of second switches, coupled to the DC link. The controller is coupled to the AC-DC converter and the DC-DC converter and configured to: detect a first detection signal of the AC-DC converter and a second detection signal of the DC-DC converter; in response to the first detection signal being in an abnormal state, reduce the DC link voltage through the second switches; and in response to the second detection signal being in the abnormal state, reduce the DC link voltage through the first switches. Input terminals of the transformer modules are connected in series, and output terminals of the transformer modules are connected in parallel.

According to the embodiments of the present disclosure, the transformer module and the solid state transformer of the present disclosure can utilize the first switch and the second switch thereof to reduce the DC link voltage when the transformer module enters the bypass mode.

### BRIEF DESCRIPTION OF THE DRAWINGS

FIG. 1 is a schematic diagram of a transformer module according to an embodiment of the present disclosure.

FIG. 2 is a schematic diagram of a transformer module according to an embodiment of the present disclosure.

FIG. 3 is a waveform diagram of pulse width modulation signals according to an embodiment of the present disclosure.

FIG. 4 is a schematic diagram of a solid state transformer according to an embodiment of the present disclosure.

### DETAILED DESCRIPTION

The embodiments are described in detail below with reference to the appended drawings to better understand the aspects of the present disclosure. However, the provided embodiments are not intended to limit the scope of the disclosure, and the description of the structural operation is not intended to limit the order in which they are performed. Any device that has been recombined by components and produces an equivalent function is within the scope covered by the disclosure.

The terms used in the entire specification and the scope of the patent application, unless otherwise specified, generally have the ordinary meaning of each term used in the field, the content disclosed herein, and the particular content.

The terms "coupled" or "connected" as used herein may mean that two or more elements are directly in physical or electrical contact, or are indirectly in physical or electrical contact with each other. It can also mean that two or more elements interact with each other.

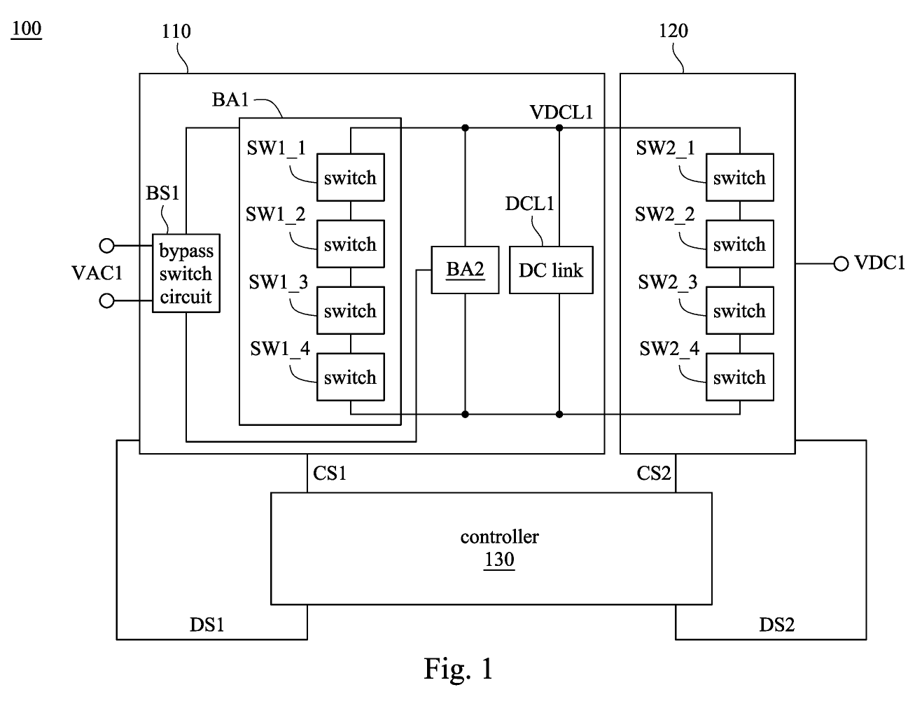

Referring to FIG. 1. FIG. 1 is a schematic diagram of a transformer module 100 according to an embodiment of the present disclosure. In the embodiment of FIG. 1, the transformer module 100 includes an AC-DC converter 110, a DC-DC converter 120, and a controller 130.

The AC-DC converter 110 may be a bridge type AC-DC converter circuit or any well-known AC-DC converter circuit configured to receive an AC voltage and converting it into a DC voltage. In this embodiment, the AC-DC converter 110 receives an AC voltage VAC1 by an input terminal. The AC-DC converter 110 includes a bypass switch circuit BS1, a bridge arm BA1, a bridge arm BA2, and a DC link DCL1. The bypass switch circuit BS1 can be configured to control whether the AC voltage VAC1 flows from the input terminal of the AC-DC converter 110 into the AC-DC converter 110. An input terminal of the bypass switch circuit BS1 can receive an AC voltage VAC1, one output terminal of the bypass switch circuit BS1 is coupled to the bridge arm BA1, and another output terminal of the bypass switch circuit BS1 is coupled to the bridge arm BA2. The bridge arm BA1 and the bridge arm BA2 can convert the AC voltage VAC1 from the bypass switch circuit BS1 into a DC voltage, and apply the DC voltage to the DC link DCL1 to generate a DC link voltage VDCL1.

The bridge arm BA1 can be coupled to the bypass switch circuit BS1 to receive the AC voltage VAC1. The bridge arm BA1 includes switches SW1_1, SW1_2, SW1_3, and SW1_4. The switches SW1_1, SW1_2, SW1_3, and SW1_4 are connected in series. The switches SW1_1, SW1_2, SW1_3, and SW1_4 may be transistor switch elements.

The DC link DCL1 is coupled to the bridge arm BA1 and the bridge arm BA2 to generate a DC link voltage VDCL1. Specifically, the DC link DCL1 can be connected in parallel with bridge arm BA1 and bridge arm BA2, a first terminal of DC link DCL1 can be coupled to one terminal of switch SW1_1, and a second terminal of DC link DCL1 can be coupled to one terminal of switch SW1_4, so that switches SW1_1, SW1_2, SW1_3, and SW1_4 can receive the DC link voltage VDCL1 by connected in series.

The DC-DC converter 120 may be a DC transformer, a DC voltage regulator circuit or any well-known DC-DC conversion circuit for adjusting and outputting a DC voltage from its input terminal.

In this embodiment, the DC-DC converter 120 is coupled to the DC link DCL1. The DC-DC converter 120 receives the DC link voltage VDCL1 through an input terminal, and outputs a DC voltage VDC1 according to the DC link voltage VDCL1.

The DC-DC converter 120 includes switches SW2_1, SW2_2, SW2_3, and SW2_4. The switches SW2_1, SW2_2, SW2_3, and SW2_4 are connected in series, and one terminal of the switch SW2_1 and one terminal of the switch SW2_4 are respectively coupled to the two terminals of the DC link DCL1, so that the switches SW2_1, SW2_2, SW2_3, and SW2_4 can receive the DC link voltage VDCL1 by connected in series. Furthermore, the switches SW2_1, SW2_2, SW2_3, and SW2_4 may be transistors or any well-known components for turning on or off a circuit, and this disclosure is not limited thereto.

The controller 130 is coupled to the AC-DC converter 110 and the DC-DC converter 120. The controller 130 may receive and detect a detection signal DS1 of the AC-DC converter 110 and a detection signal DS2 of the DC-DC converter 120.

In this embodiment, the detection signal DS1 is configured to indicate whether the AC-DC converter 110 operates normally. When the detection signal DS1 is in a normal state, it means that the AC-DC converter 110 operates normally; and when the detection signal DS1 is in an abnormal state, it means that the AC-DC converter 110 may fail. The detection signal DS1 may be any signal in the AC-DC converter 110 (i.e., at least one of the input current in the AC-DC converter 110, the internal component voltage not shown in FIG. 1, or the DC link voltage VDCL1, which is not limited in the this disclosure).

When the detection signal DS1 is in the abnormal state, the AC-DC converter 110 fails, and the controller 130 can turn on the bypass switch circuit BS1 to make the transformer module 100 enter the bypass mode. In the bypass mode, the input terminal of the AC-DC converter 110 is short-circuited to try to block the AC voltage VAC1 from flowing into the AC-DC converter 110. During this period, the controller 130 can detect the voltage value of the DC link voltage VDCL1 increased due to the discharge of the stray capacitance inside the AC-DC converter 110. When the voltage value of the DC link voltage VDCL1 increases to a preset maximum value (for example, the voltage value of the DC link voltage VDCL1 increases by 5% from the time when the detection signal DS1 enters the abnormal state, and this disclosure does not limit the specific voltage value), the controller 130 can control the switches SW2_1, SW2_2, SW2_3, and SW2_4 of the DC-DC converter 120 through the control signal CS2, and utilize the switches SW2_1, SW2_2, SW2_3, and SW2_4 to reduce the DC link voltage VDCL1 (for example, the DC link voltage VDCL1 can be reduced to 50%, 10%, or zero volts of the voltage value when it enters the abnormal state, and this disclosure does not limit the specific voltage value).

In this embodiment, the detection signal DS2 is configured to indicate whether the DC-DC converter 120 operates normally. When the detection signal DS2 is in the normal state, it means that the DC-DC converter 120 operates normally; and when the detection signal DS2 is in the abnormal state, it means that the DC-DC converter 120 may fail. The detection signal DS2 may be any signal in the DC-DC converter 120 (i.e., at least one of the input current in the DC-DC converter 120, the DC voltage VDC1, or the output current of the DC-DC converter 120, which is not limited in this disclosure).

When the detection signal DS2 is in the abnormal state, the DC-DC converter 120 fails, and the controller 130 can also make the transformer module 100 enter the bypass mode. During this period, the controller 130 can detect the voltage value of the DC link voltage VDCL1. When the voltage value of the DC link voltage VDCL1 increases to the preset maximum value, the controller 130 controls the switches SW1_1, SW1_2, SW1_3, and SW1_4 in the AC-DC converter 110 by the control signal CS1, and utilizes the switches SW1_1, SW1_2, SW1_3, and SW1_4 to reduce the DC link voltage VDCL1 (i.e., the DC link voltage VDCL1 may be reduced to 50%, 10%, or zero volts of the voltage value when it enters the abnormal state, and this disclosure is not limited to the specific voltage value).

In this embodiment, the controller 130 can repeatedly switch the switches SW1_1, SW1_2, SW1_3, and SW1_4 by the control signal CS1, or repeatedly switch the switches SW2_1, SW2_2, SW2_3, and SW2_4 by the control signal CS2, and utilize the hard switching loss of these switches to consume the DC link voltage VDCL1, thereby reducing the DC link voltage VDCL1.

In addition to the above, in some embodiments, if the detection signals DS1 and DS2 are both in an abnormal state, the controller 130 may activate the overvoltage protect function of the transformer module 100 to shut down the transformer module 100 when the DC link voltage VDCL1 increases to the preset maximum value.

In summary, the transformer module 100 can utilize the switches SW1_1, SW1_2, SW1_3, SW1_4 and the switches SW2_1, SW2_2, SW2_3, SW2_4 to reduce the DC link voltage VDCL1 after the transformer module 100 enters the bypass mode.

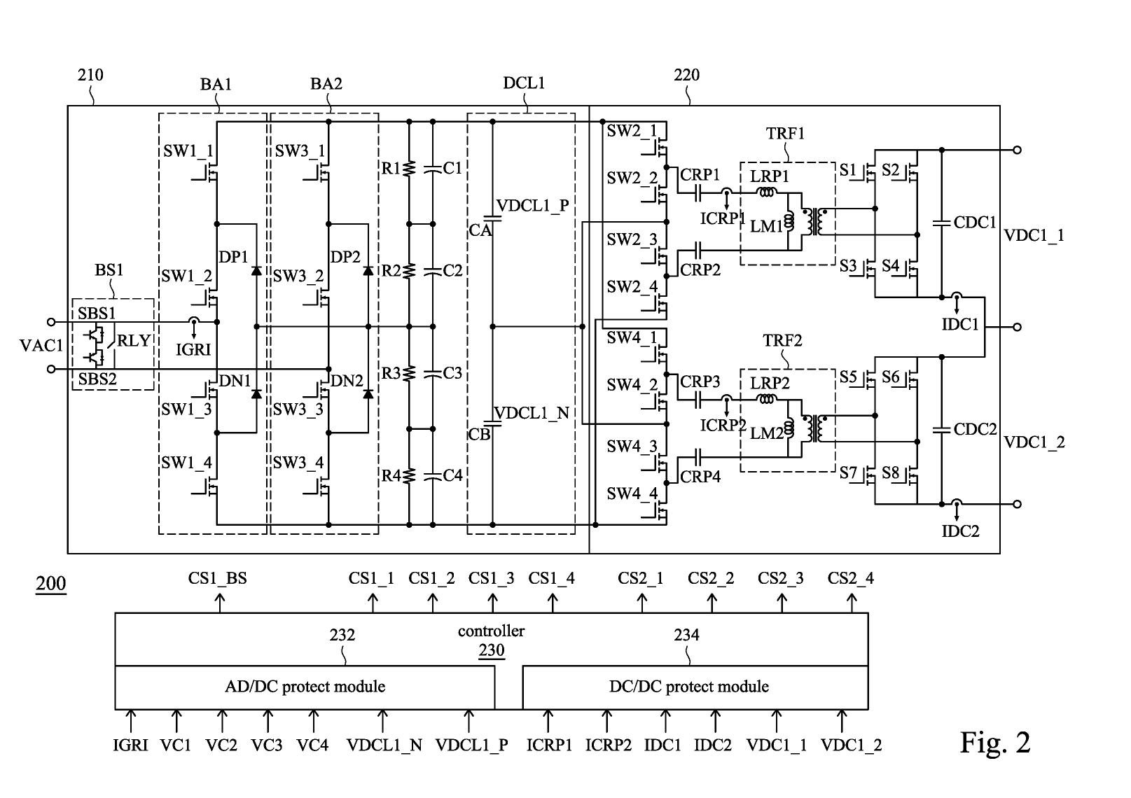

Referring to FIG. 2. FIG. 2 is a schematic diagram of a transformer module 200 according to an embodiment of the present disclosure. In FIG. 2, transformer module 200 includes an AC-DC converter 210, a DC-DC converter 220, and a controller 230. The transformer module 200 in FIG. 2 may correspond to the transformer module 100 in FIG. 1. Specifically, transformer module 200 may be configured to represent the component configuration details of transformer module 100, and AC-DC converter 210, DC-DC converter 220, and controller 230 in FIG. 2 may correspond to AC-DC converter 110, DC-DC converter 120, and controller 130 in FIG. 1, respectively.

In an embodiment of FIG. 2, the AC-DC converter 210 includes a bypass switch circuit BS1, a bridge arm BA1, a bridge arm BA2, and a DC link DCL1. Furthermore, the AC-DC converter 210 further includes resistors R1, R2, R3, and R4 and capacitors C1, C2, C3, and C4. Resistors R1, R2, R3, and R4 are connected in series. A first terminal of resistor R1 is coupled to a first terminal of DC link DCL1, a second terminal of resistor R1 is coupled to a first terminal of resistor R2, a second terminal of resistor R2 is coupled to a first terminal of resistor R3, a second terminal of resistor R3 is coupled to a first terminal of resistor R4, and a second terminal of resistor R4 is coupled to a second terminal of DC link DCL1. The resistor R1 is connected in parallel with the capacitor C1, the resistor R2 is connected in parallel with the capacitor C2, the resistor R3 is connected in parallel with the capacitor C3, and the resistor R4 is connected in parallel with the capacitor C4.

The bypass switch circuit BS1 includes switches SBS1, SBS2 and a copper switch RLY. Two terminals of the input terminal of the AC-DC converter 210 are respectively coupled to a first terminal of the switch SBS1 and a second terminal of the switch SBS2. The second terminal of the switch SBS1 is coupled to a first terminal of the switch SBS2. Two terminals of the copper switch RLY are respectively coupled to a first terminal of the switch SBS1 and a second terminal of the switch SBS2.

The bridge arm BA1 includes switches SW1_1, SW1_2, SW1_3, SW1_4 and diodes DP1, DN1. A first terminal of the switch SW1_1 is coupled to the bridge arm BA2 and a first terminal of the resistor R1, a second terminal of the switch SW1_1 is coupled to a first terminal of the switch SW1_2 and a cathode terminal of the diode DP1. A second terminal of the switch SW1_2 is coupled to the first terminal of the switch SBS1 of the bypass switch circuit BS1, a first terminal of the copper switch RLY, and the first terminal of the switch SW1_3. The second terminal of the switch SW1_3 is coupled to the first terminal of the switch SW1_4 and the anode terminal of the diode DN1. A second terminal of the switch SW1_4 is coupled to the bridge arm BA2 and a second terminal of the resistor R4. The anode terminal of the diode DP1 is coupled to the cathode terminal of the diode DN1, the anode terminal of the diode DP2, the cathode terminal of the diode DN2, the resistors R2 and R3, and the capacitors C2 and C3.

The bridge arm BA2 includes switches SW3_1, SW3_2, SW3_3, SW3_4 and diodes DP2, DN2. A first terminal of the switch SW3_1 is coupled to the bridge arm BA1 and a first terminal of the resistor R1, a second terminal of the switch SW3_1 is coupled to a first terminal of the switch SW3_2 and a cathode terminal of the diode DP2. A second terminal of the switch SW3_2 is coupled to the second terminal of the switch SBS2 of the bypass switch circuit BS1, the second terminal of the copper switch RLY, and the first terminal of the switch SW3_3. A second terminal of the switch SW3_3 is coupled to the first terminal of the switch SW3_4 and the anode terminal of the diode DN2. A second terminal of the switch SW3_4 is coupled to the bridge arm BA1 and a second terminal of the resistor R4.

The DC link DCL1 includes capacitors CA and CB. A first terminal of the capacitor CA is coupled to a first terminal of the switch SW1_1 of the bridge arm BA1 and a first terminal of the switch SW3_1 of the bridge arm BA2. A second terminal of the capacitor CA is coupled to the first terminal of the capacitor CB. A second terminal of the capacitor CB is coupled to a second terminal of the switch SW1_4 of the bridge arm BA1 and a second terminal of the switch SW3_4 of the bridge arm BA2.

When the transformer module 200 operates normally, the bypass switch circuit BS1 is not turned on, the current IGRI can flow from the input terminal of the AC-DC converter 110 through the first terminal of the switch SBS1 and the first terminal of the copper switch RLY, and flow to the second terminal of the switch SW1_2, and then flow into the bridge arm BA1. A voltage VC1 may be generated at two terminals of the capacitor C1, a voltage VC2 may be generated at two terminals of the capacitor C2, a voltage VC3 may be generated at two terminals of the capacitor C3, and a voltage VC4 may be generated at two terminals of the capacitor C4. The two terminals of the capacitor CA can generate a DC link voltage VDCL1_P, and the two terminals of the capacitor CB can generate a DC link voltage VDCL1_N. The DC link voltages VDCL1_P and VDCL1_N in FIG. 2 can be used alone or in combination as the DC link voltage VDCL1 in FIG. 1.

In this embodiment, the DC-DC converter 220 includes switches SW 2_1, SW2_2, SW2_3, SW2_4, S1, S2, S3, S4, capacitors CRP1, CRP2, CDC1, and a transformer circuit TRF1. The transformer circuit TRF1 includes inductors LRP1 and LM1. The DC-DC converter 220 further includes switches SW4_1, SW4_2, SW4_3, SW4_4, S5, S6, S7, S8, capacitors CRP3, CRP4, CDC2, and a transformer circuit TRF2. The transformer circuit TRF2 includes inductors LRP2 and LM2.

A first terminal of the switch SW 2_1 is coupled to a first terminal of the capacitor CA of the DC link DCL1. A second terminal of the switch SW 2_1 is coupled to the first terminal of the switch SW 2_2 and the first terminal of the capacitor CRP1. A second terminal of the switch SW 2_2 is coupled to the first terminal of the switch SW 2_3, a second terminal of the capacitor CA, and the first terminal of the capacitor CB. A second terminal of the switch SW 2_3 is coupled to a first terminal of the switch SW 2_4 and a first terminal of the capacitor CRP2. A second terminal of the switch SW 2_4 is coupled to a second terminal of the capacitor CB. The capacitor CRP1 and the capacitor CRP2 are coupled to the transformer circuit TRF1. A second terminal of the capacitor CRP1 is coupled to the inductor LRP1. A second terminal of the capacitor CRP2 is coupled to the inductor LM1 and transmits a current ICRP1 to the inductor LM1.

A first terminal of the switch SW 4_1 is coupled to a first terminal of the capacitor CA of the DC link DCL1. A second terminal of the switch SW 4_1 is coupled to the first terminal of the switch SW 4_2 and the first terminal of the capacitor CRP3. A second terminal of the switch SW 4_2 is coupled to the first terminal of the switch SW 4_3, a second terminal of the capacitor CA, and a first terminal of the capacitor CB. A second terminal of the switch SW 4_3 is coupled to a first terminal of the switch SW 4_4 and a first terminal of the capacitor CRP4. A second terminal of the switch SW 4_4 is coupled to a second terminal of the capacitor CB. The capacitor CRP3 and the capacitor CRP4 are coupled to the transformer circuit TRF2. The second terminal of the capacitor CRP3 is coupled to the inductor LRP2. A second terminal of the capacitor CRP4 is coupled to the inductor LM2 and transmits a current ICRP2 to the inductor LM2.

In the present embodiment, switches SBS1, SBS2, SW1_1, SW1_2, SW1_3, SW1_4, SW2_1, SW2_2, SW2_3, SW2_4, SW3_1, SW3_2, SW3_3, SW3_4, SW4_1, SW4_2, SW4_3, SW4_4, S1, S2, S3, S4, S5, S6, S7, and S8 may be well-known transistor switch elements.

When the transformer module 200 operates normally, the DC-DC converter 220 can receive the DC link voltages VDCL1_P and VDCL1_N from the DC link DCL1. In the DC-DC converter 220, two terminals of the capacitor CDC1 can generate a DC voltage VDC1_1 and a DC output current IDC1. The two terminals of the capacitor CDC2 can generate a DC voltage VDC1_2 and a DC output current IDC2. The DC voltage VDC1_1 and the DC voltage VDC1_2 in FIG. 2 can both be used as the DC voltage VDC1 in FIG. 1.

The controller 230 includes an alternating current-to-direct current (AC/DC) protect module 232 and a direct current-to-direct current (DC/DC) protect module 234. The AC/DC protect module 232 is configured to detect a plurality of detection signals (corresponding to the detection signal DS1 in FIG. 1) of the AC-DC converter 210 and determine whether the AC-DC converter 210 operates normally. The plurality of detection signals include a current IGRI, a voltage VC1, a voltage VC2, a voltage VC3, a voltage VC4, a DC link voltage VDCL1_P, and a DC link voltage VDCL1_N. The DC/DC protect module 234 is configured to detect the plurality of detection signals (corresponding to the detection signal DS2 in FIG. 1) of the DC-DC converter 220 and determine whether the DC-DC converter 220 operates normally. The plurality of detection signals include a current ICRP1, a current ICRP2, a DC output current IDC1, a DC output current IDC2, a DC voltage VDC1_1, and a DC voltage VDC1_2.

The controller 230 has a built-in voltage and current table. When one of the above voltage and current values does not meet the preset value range (for example, being higher or lower than a preset level to a certain extent), it can be determined that the AC-DC converter 210 or the DC-DC converter 220 may fail. When at least one of the AC-DC converter 210 or DC-DC converter 220 fails, the controller 230 can control the plurality of switches in the bypass switch circuit BS1, the AC-DC converter 210 and the DC-DC converter 220 by control signals CS1_BS, CS1_1, CS1_2, CS1_3, CS1_4, CS2_1, CS2_2, CS2_3, CS2_4.

When the AC/DC protect module 232 determines that the AC-DC converter 210 fails or the DC/DC protect module 234 determines that the DC-DC converter 220 fails, the transformer module 200 enters the bypass mode, and the controller 230 can adjust the control signal CS1_BS. In this embodiment, the control terminals of the switches SBS1, SBS2 and the copper switch RLY all receive the control signal CS1_BS. The control signal CS1_BS can turn on the bypass switch circuit BS1 when a failure occurs in the AC-DC converter 210 or the DC-DC converter 220, thereby short-circuiting the input terminal of the AC-DC converter 210.

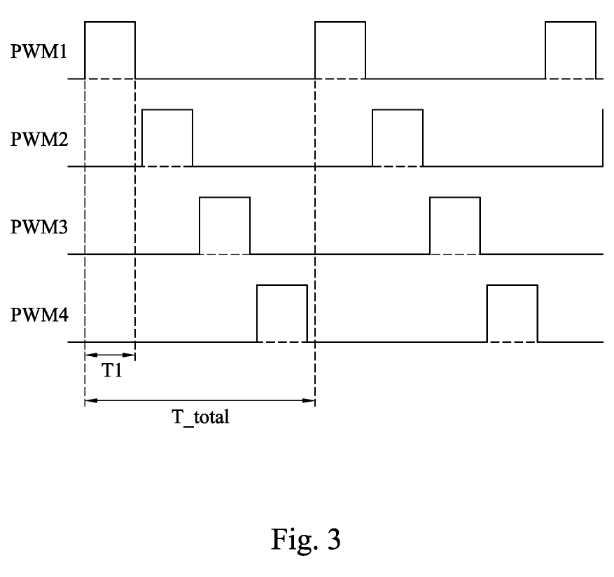

When the AC/DC protect module 232 determines that the AC-DC converter 210 fails and the DC-DC converter 220 can operate normally, the transformer module 200 enters the bypass mode, and the control signals CS1_1, CS1_2, CS1_3, and CS1_4 can be set to a constant voltage to turn off the switches in the AC-DC converter 210; the control signals CS2_1, CS2_2, CS2_3, and CS2_4 can be set to a pulse width modulation signal; and the control signal CS2_1 can be transmitted to the control terminal of the switch SW2_1, the control signal CS2_2 can be transmitted to the control terminal of the switch SW2_2, the control signal CS2_3 can be transmitted to the control terminal of the switch SW2_3, and the control signal CS2_4 can be transmitted to the control terminal of the switch SW2_4, so that the switches SW2_1, SW2_2, SW2_3, and SW2_4 are conducted by time-sharing, as shown in FIG. 3.

Referring to FIGS. 2 and 3 at the same time. FIG. 3 is a waveform diagram of pulse width modulation signals PWM1-PWM4 according to an embodiment of the present disclosure. The period of each of the pulse width modulation signals PWM1 to PWM4 is a time length T_total, the working time length of the pulse wave is a time length T1, and the working period is less than 25 %. The pulse width modulation signal PWM1~PWM4 enter the working time in sequence, that is, the pulse width modulation signal PWM1 can output pulse first, followed by the pulse width modulation signal PWM2, PWM3, PWM4 output pulse in sequence, and then it is the turn of the pulse width modulation signal PWM1 to output pulse again, and the cycle repeats.

According to the above embodiment in FIG. 2, when the AC/DC protect module 232 determines that the AC-DC converter 210 fails and the DC-DC converter 220 can operate normally, the control signals CS2_1~CS2_4 can be respectively set to the pulse width modulation signals PWM1~PWM4, so that the switches SW2_1, SW2_2, SW2_3, and SW2_4 are switched in sequence. In this way, the switches SW2_1, SW2_2, SW2_3, and SW2_4 can utilize the hard switching loss of the switches to consume the DC link voltages VDCL1_P and VDCL1_N, thereby reducing the DC link voltages VDCL1_P and VDCL1_N.

In some embodiments, the control signal CS2_1 may be transmitted to the control terminal of the switch SW4_1, the control signal CS2_2 may be transmitted to the control terminal of the switch SW4_2, the control signal CS2_3 may be transmitted to the control terminal of the switch SW4_3, and the control signal CS2_4 may be transmitted to the control terminal of the switch SW4_4, so that the synchronization of the switches SW4_1~SW4_4 and the switches SW2_1~SW2_4 is conducted by time-sharing, thereby causing the DC link voltages VDCL1_P and VDCL1_N to drop faster.

Following the above embodiment in FIG. 2, when the DC/DC protect module 234 determines that the DC-DC converter 220 fails and the AC-DC converter 210 can operate normally, the control signals CS2_1, CS2_2, CS2_3, and CS2_4 can be set to a constant voltage to turn off the switches in the DC-DC converter 220; the control signals CS1_1, CS1_2, CS1_3, and CS1_4 can be set as pulse width modulation signal, and the control signal CS1_1 can be transmitted to the control terminal of the switch SW1_1, the control signal CS1_2 can be transmitted to the control terminal of the switch SW1_2, the control signal CS1_3 can be transmitted to the control terminal of the switch SW1_3, and the control signal CS1_4 can be transmitted to the control terminal of the switch SW1_4, so that the switches SW1_1, SW1_2, SW1_3, and SW1_4 are conducted by time-sharing, as specifically shown in FIG. 3. In this case, the control signals CS1_1~CS1_4 can be respectively set as pulse width modulation signals PWM1~PWM4, so that the switches SW1_1, SW1_2, SW1_3, and SW1_4 are switched in sequence. In this way, the switches SW1_1, SW1_2, SW1_3, and SW1_4 can utilize the hard switching loss of the switches to consume the DC link voltages VDCL1_P and VDCL1_N, thereby reducing the DC link voltages VDCL1_P and VDCL1_N.

In some embodiments, the control signal CS1_1 may be transmitted to the control terminal of the switch SW3_1, the control signal CS1_2 may be transmitted to the control terminal of the switch SW3_2, the control signal CS1_3 may be transmitted to the control terminal of the switch SW3_3, and the control signal CS1_4 may be transmitted to the control terminal of the switch SW3_4, so that the synchronization of the switches SW3_1~SW3_4 and the switches SW1_1~SW1_4 is conducted by time-sharing, thereby causing the DC link voltages VDCL1_P and VDCL1_N to drop faster.

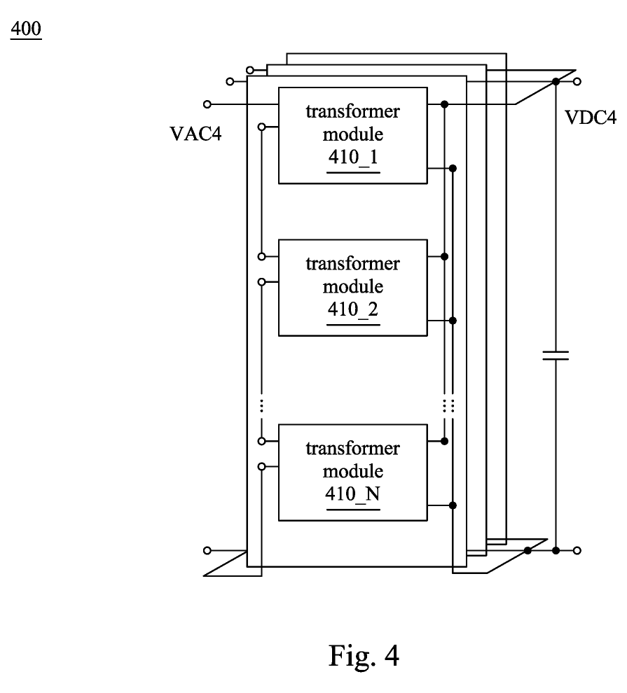

Referring to FIG. 4. FIG. 4 is a schematic diagram of a solid state transformer 400 according to an embodiment of the present disclosure. The solid state transformer 400 may be a three-phase AC-DC voltage conversion circuit. Each phase of the solid state transformer 400 includes a plurality of transformer modules (i.e., transformer modules 410_1, 410_2,... 410_N in FIG. 4, where “N” may be any positive integer greater than 2; in some embodiments, the phase of the solid state transformer 400 may only include the transformer modules 410_1, 410_2, and this disclosure has no limitation on the number of transformer modules).

FIG. 4 may correspond to the transformer module 100 in FIG. 1 and the transformer module 200 in FIG. 2. Therefore, the configuration and characteristics of the components of the transformer modules 410_1 to 410_N are not described in detail herein.

It is worth mentioning that input terminals of transformer modules 410_1 to 410_N are connected in series. The transformer modules 410_1~410_N can evenly share the AC voltage VAC4, that is, the voltage value received by the input terminal of each of the transformer modules 410_1~410_N is 1/N times the AC voltage VAC4.

In addition, the output terminals of transformer modules 410_1~410_N are connected in parallel. The output voltage of each transformer module 410_1~410_N is the same (i.e., the DC voltage VDC4).

In summary, the transformer module and the solid state transformer of this disclosure can utilize their own first switch and second switch to reduce the DC link voltage after the transformer module enters the bypass mode.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A transformer module, comprising:
an AC-DC converter, configured to receive an AC voltage, comprising:
a bypass switch circuit;
a first bridge arm, coupled to the bypass switch circuit, having a plurality of first switches;
a second bridge arm, coupled to the first bridge arm; and
a DC link, coupled to the first bridge arm and the second bridge arm, configured to generate a DC link voltage;
a DC-DC converter, coupled to the DC link, configured to receive the DC link voltage, and the DC-DC converter comprising:
a plurality of second switches, coupled to the DC link; and
a controller, coupled to the AC-DC converter and the DC-DC converter, and the controller being configured to:
detect a first detection signal of the AC-DC converter and a second detection signal of the DC-DC converter;
in response to the first detection signal being in an abnormal state, reduce the DC link voltage through the second switches; and
in response to the second detection signal being in the abnormal state, reduce the DC link voltage through the first switches.

2. The transformer module of claim 1, wherein the controller is further configured to:
in response to the first detection signal and the second detection signal being in the abnormal state at same time, detect whether the DC link voltage increases to a preset maximum value, so as to shut down the transformer module.

3. The transformer module of claim 1, wherein the controller is further configured to:
in response to the first detection signal being in the abnormal state, turn on the bypass switch circuit and detect whether the DC link voltage increases from a first voltage level to a second voltage level; and
in response to the DC link voltage being greater than or equal to the second voltage level, reduce the DC link voltage to below the first voltage level by the second switches.

4. The transformer module of claim 1, wherein the controller is further configured to:
in response to the second detection signal being in the abnormal state, turn on the bypass switch circuit and detect whether the DC link voltage increases from a first voltage level to a second voltage level; and
in response to the DC link voltage being greater than or equal to the second voltage level, reduce the DC link voltage to below the first voltage level by the first switches.

5. The transformer module of claim 1, wherein the controller is further configured to:
generate a plurality of pulse width modulation signals;
in response to the first detection signal being in the abnormal state, turn on a corresponding one of the second switches through each of the pulse width modulation signals, wherein each of the second switches is turned on in a time-sharing manner; and
in response to the second detection signal being in the abnormal state, turn on a corresponding one of the first switches through each of the pulse width modulation signals, wherein each of the first switches is turned on in a time-sharing manner.

6. The transformer module of claim 1, wherein the first switches and the second switches both utilize a hard switching loss to reduce the DC link voltage.

7. The transformer module of claim 1, wherein the second bridge arm comprises a plurality of third switches,
wherein in response to the second detection signal being in the abnormal state, the controller reduces the DC link voltage by the first switches and the third switches.

8. The transformer module of claim 1, wherein the DC-DC converter further comprises:
a plurality of fourth switches coupled to the DC link,
wherein in response to the first detection signal being in the abnormal state, the controller reduces the DC link voltage by the second switches and the fourth switches.

9. The transformer module of claim 1, wherein,
the first detection signal is generated based on at least one of an input current of the AC-DC converter, a first internal voltage and the DC link voltage,
the second detection signal is generated based on at least one of an input current of the DC-DC converter, an output voltage of the DC-DC converter, and an output current of the DC-DC converter.

10. A solid state transformer, configured to receive an AC voltage, and the solid state transformer comprising:
a plurality of transformer modules, each of the transformer modules comprising:
an AC-DC converter, configured to receive an AC voltage, comprising:
a bypass switch circuit;
a first bridge arm, coupled to the bypass switch circuit, having a plurality of first switches;
a second bridge arm, coupled to the first bridge arm; and
a DC link, coupled to the first bridge arm and the second bridge arm, configured to generate a DC link voltage;
a DC-DC converter, coupled to the DC link, configured to receive the DC link voltage, and the DC-DC converter comprising:
a plurality of second switches, coupled to the DC link; and
a controller, coupled to the AC-DC converter and the DC-DC converter, and the controller configured to:
detect a first detection signal of the AC-DC converter and a second detection signal of the DC-DC converter;
in response to the first detection signal being in an abnormal state, reduce the DC link voltage through the second switches; and
in response to the second detection signal being in the abnormal state, reduce the DC link voltage through the first switches,
wherein input terminals of the transformer modules are connected in series, and output terminals of the transformer modules are connected in parallel.

11. The solid state transformer of claim 10, wherein the controller is further configured to:
in response to the first detection signal and the second detection signal being in the abnormal state at same time, detect whether the DC link voltage increases to a preset maximum value, so as to shut down the transformer modules.

12. The solid state transformer of claim 10, wherein the controller is further configured to:
in response to the first detection signal being in the abnormal state, turn on the bypass switch circuit and detect whether the DC link voltage increases from a first voltage level to a second voltage level; and
in response to the DC link voltage being greater than or equal to the second voltage level, reduce the DC link voltage to below the first voltage level by the second switches.

13. The solid state transformer of claim 10, wherein the controller is further configured to:
in response to the second detection signal being in the abnormal state, turn on the bypass switch circuit and detect whether the DC link voltage increases from a first voltage level to a second voltage level; and
in response to the DC link voltage being greater than or equal to the second voltage level, reduce the DC link voltage to below the first voltage level by the first switches.

14. The solid state transformer of claim 10, wherein the controller is further configured to:
generate a plurality of pulse width modulation signals;
in response to the first detection signal being in the abnormal state, turn on a corresponding one of the second switches through each of the pulse width modulation signals, wherein each of the second switches is turned on in a time-sharing manner; and
in response to the second detection signal being in the abnormal state, turn on a corresponding one of the first switches through each of the pulse width modulation signals, wherein each of the first switches is turned on in a time-sharing manner.

15. The solid state transformer of claim 10, wherein the first switches and the second switches both utilize a hard switching loss to reduce the DC link voltage.

16. The solid state transformer of claim 10, wherein,
the first detection signal is generated based on at least one of an input current of the AC-DC converter, a first internal voltage and the DC link voltage,
the second detection signal is generated based on at least one of an input current of the DC-DC converter, an output voltage of the DC-DC converter, and an output current of the DC-DC converter.
